(19) United States
(12) Patent Application Publication
(10) Pub. No.: US 2006/0265756 A1
(43) Pub. Date: Nov. 23, 2006

(54) Disk protection using enhanced write filter

(75) Inventors: Derick A. Campbell, Bellevue, WA (US); Jose F. Maldonado, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/336,482

(22) Filed: Jan. 20, 2006

Related U.S. Application Data
(60) Provisional application No. 60/679,715, filed on May 11, 2005.

(51) Int. Cl. H04N 7/16

(52) U.S. Cl. 726/26

(57) ABSTRACT

Protection of a writable disk through utilization of a protection partition is provided. Critical updates and other designated program updates can be automatically applied to the writable disk without user intervention. Machine account password changes for domain-joined computers can be initiated and saved during a critical update and/or save change process. Local user account password changes can be permanently saved using the save change process, thus preserving the password change. Information directed to the protection partition can be saved to the writable media through a user save request. The information in the protection partition can be retained indefinitely and/or deleted without affecting the writable media. The protection partition can be automatically refreshed upon each restart. A user can interact with the disk protection system through a user interface that facilitates modifying one or more parameter associated with the protection partition.

### CROSS-REFERENCE TO RELATED APPLICATIONS

This application claims the benefit of U.S. Provisional Application Ser. No. 60/679,715, filed May 11, 2005, entitled “DISK PROTECTION USING ENHANCED WRITE FILTER.” The entirety of this application is incorporated herein by reference.

### BACKGROUND

Computer systems have become widely used and the transfer of data between computer systems has increased dramatically. This data transfer increase has resulted in a corresponding increase in the transfer of malicious software (malware) designed to damage and/or disrupt computer systems. Some common forms of malware are viruses, worms, and Trojan horses. A virus is a program or piece of code that automatically copies itself and can “infect” disks or programs and which is generally undetected by the system user. A worm is a program or algorithm that replicates itself and can perform various malicious acts, such as depleting system resources. A Trojan horse is a program that appears benign but has hidden destructive functions, such as erasing disks on a certain day.

Another problem associated with computer systems is the development of spyware, which is software that secretly gathers personal information about a user through such user's Internet connection, for example. Spyware is typically utilized for advertising purposes and can run secretly in the system background, recording some or all of the user's actions.

Most malware and spyware is installed on a computer system when data is downloaded or saved. Once malware and/or spyware have been installed, they are generally undetected and can harm the system. An approach utilized to eliminate malware and spyware is to completely reinstall the operating system, all applications, and configurations. However, doing so can also remove information from the computer system, which cannot thereafter be recovered.

In the shared computer environments (e.g., libraries, schools, Internet cafes, . . . ) unknown and/or untrustworthy users might intentionally or unintentionally download content that damages an operating environment. Users of such shared computers may also initiate undesired changes to the system resulting in those changes affecting other shared computer users as well as the entire operating system.

Therefore, there is a need to mitigate the “installation” of malware and spyware onto a computer system. Additionally there is a need to protect the operating system from unintended and/or undesired changes.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

The systems and/or methods disclosed and claimed herein, in an aspect thereof, comprise a customized computer installation program that can provide protection from malware and/or spyware. An enhanced write filter can be utilized to protect writable media (e.g., disk partition containing the operating system, applications, settings, . . . ) from undesired and/or unintended changes. The changes can be temporarily stored in a partition, such as a protection partition. The temporary changes can be erased or removed from the protection partition and not applied to the writable media, retaining or returning the writable media to its previous known state and/or health state. According to another aspect, the temporary changes can be saved and applied to the writable media by authorized users, rendering the changes permanent.

Still yet another aspect is a system and/or method that allow indefinite temporary changes (including installations) to be maintained in a protection partition by preventing an enhanced write filter from refreshing the protection partition upon each reboot. The indefinite temporary changes can be retained in the protection partition until they are saved to the local disk or cleared from the protection partition.

Yet another aspect is a system and/or method that allow critical updates to be automatically downloaded and installed to a protection partition. A disk protection system can log off or disable a user from inputting data to the protection partition and/or saving data to the local disk at substantially the same time as the critical update is applied to the local disk. Thus, mitigating and/or eliminating the possibility of unintended data being applied to the local disk with the critical update. This allows the underlying operating system to continue to be updated with the latest software and protection.

According to yet another aspect is a system and/or method of facilitating password changes on a domain-joined computer in systematic manner. The password change can be executed at substantially the same time as a critical update is applied to the local disk. According to another embodiment, the password change can be initiated and executed at substantially the same time as data located in the protection partition is saved to the local disk.

To the accomplishment of the foregoing and related ends, one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that protects a local disk through utilization of an enhanced write filter.

FIG. 2 illustrates a system that protects a writable media by applying modifications to a protection partition.

FIG. 3 illustrates a system level diagram of components in a computer system that facilitate disk protection.

FIG. 4 illustrates a flow chart of a methodology for maintaining changes in a protection partition until such changes are to be permanently saved in the local disk.

FIG. 5 illustrates a flow chart of a methodology for applying password changes during a critical update or while changes are saved to a local disk.

FIG. 6 illustrates an exemplary user interface that can be utilized with the disclosed systems and/or methods.

FIG. 7 illustrates a block diagram of a computer operable to execute the disclosed embodiments.

FIG. 8 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

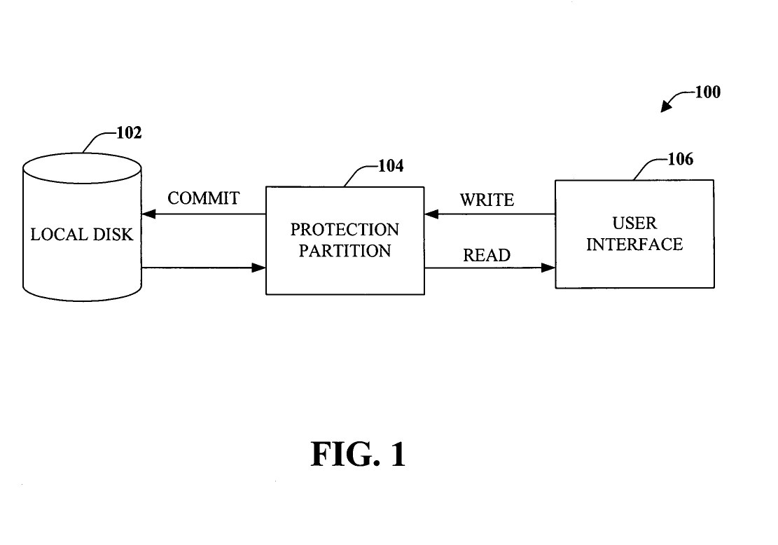

Referring initially to FIG. 1, illustrated is a system 100 that protects a local disk through utilization of an enhanced write filter. An enhanced write filter protects a volume from write access by redirecting writer operations to another storage location. System 100 includes a local disk 102 and a protection partition 104. The local disk can be, for example, the hard disk drive or “C” drive of a computer, and is generally the operating system and program files. The local disk 102 can also be any writable media for which protection from modifications, malware, and/or spyware is desired. The protection partition 104 can be unallocated space or free space in an extended partition, which is a part of a hard disk that is treated as if it is a separate disk drive.

When a user and/or entity (e.g., the Internet, another system, a computer, . . . ), hereinafter referred to as user, desires to make changes (e.g., install a program, adding a user account, configuring system settings for users, . . . ) through an user interface 106 an input or write function is applied to the protection partition 104. In some situations, a user might attempt (intentionally or unintentionally) to damage the operating system or malware and/or spyware may be input and stored on the local disk 102. Rather than allowing such changes to be automatically applied or stored to the local disk 102, the modifications are directed to a protection partition 104. In this protection partition 104 the intended modifications can be analyzed, changed, modified, deleted, etc. without such actions changing or affecting the local disk 102. When information in the protection partition 104 is determined to be safe for transfer to the local disk 102, an authorized user can save the changes, which are then applied to the local disk 102, through a commit function.

In the shared computer scenario a user, during a user session, can make necessary changes to the computer within the boundaries of that user's restrictions. When the user session is over and the system reboots, the protection partition can be cleared discarding any changes made during the user session, thus returning the local disk to its original condition. Therefore, each time the system is restarted it is returned to its original state providing the next user with a reliable operating system.

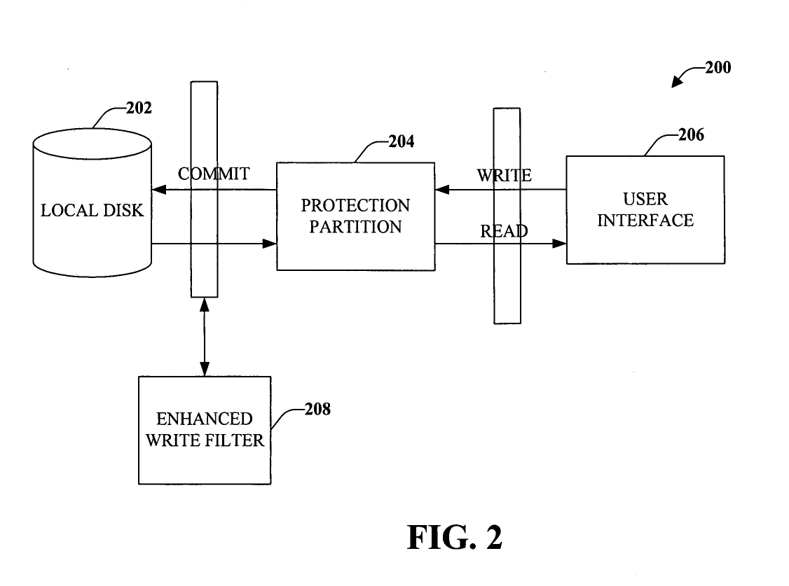

FIG. 2 illustrates a system 200 that protects a writable media by applying modifications to a protection partition. System 200 includes a local disk 02 and a protection component 204 that interfaces with an user interface 206. The local disk 202 can be any media capable of recording data, such as the disk partition containing an operating system, applications, settings, etc. It will be understood by those skilled in the art that local disk 202 can include writable media, re-writable media, storage media, and/or other objects on which data can be stored (e.g., hard disks, floppy disks, CD-ROMS, . . . ).

The protection component 204 receives an input (write) from user interface 206 that is intended to be written to the local disk 202. The input can be data, information, program, code, system software and/or application software that can be applied, downloaded, recorded, stored, etc. to the local disk 202. Alternatively or in addition, the input can include an update (e.g., critical updates, recommended updates, optional updates, driver updates, special updates) that provides that the system 200 remains up-to-date with the latest software and/or software protection.

The protection partition 204 in conjunction with the enhanced write filter 208 is similar to a transparency sheet utilized with, for example, an overhead projector. A transparency sheet can be placed over an original document and changes, alterations, etc. can be performed on the transparency sheet without altering, changing, etc. the original document. If the changes are desired, the original document can be changed to include the alterations. If the changes are not desired, the original document can be placed back in its original state by removing the transparency sheet. The protection partition 204 and enhanced write filter 208 utilize a similar concept by maintaining the temporary changes in the separate partition 208 and the original data (local disk 202) are not altered until a decision is made to make the change permanent.

Enhanced write filter (EWF) 208 protects a volume (local disk 202) from write access. The volume can be a unit of storage on the same or a separate disk (floppy or hard). Enhanced write filter 208, during a boot command, can retain, clear or commit the temporary information in protection partition 204. The protection partition 204 protects the contents of the volume or local disk 202 by redirecting write operations (temporary change(s)) to a separate storage location, for example. Such a storage location can be in RAM or on another disk portion.

The temporary changes contained in the protection partition 204 can be stored indefinitely or until such time as the changes are discarded and/or applied or saved to the local disk 202 through a commit function. There can also be a plurality of temporary changes contained in the protection partition 204 at substantially the same time. Saving changes indefinitely can be utilized, for example, when several new programs need to be installed. Enabling this mode allows a new program to be installed and tested for potential compatibility issues with other programs on the computer. Then other programs can be installed to test capability and compatibility.

The changes retained in the protection partition 204 can be cleared with each restart, saved with the next restart, retained for one restart and/or retained indefinitely. These optional functions are predetermined through a user interaction with the disk protection system, such as through a user interface.

Critical updates can be automatically applied to the local disk 202 without the necessity of redirecting or storing such updates in a protection partition 204. For example, the system 200 can infer that information from particular sources (e.g., websites, users, systems, . . . ) is reliable and/or trustworthy and can apply those updates at substantially the same time as received by the protection component 204. As used herein, the term “infer” refers generally to the process of reasoning about or inferring states of the system, environment, and/or user from a set of observations as captured through events and/or data. Thus, the protection partition 204 distinguishes between those changes that are “critical” or in some way inferred by the system 200 as having a greater importance, trust level, reliability, etc. than other received updates, downloads and/or changes. Applying the critical updates in such a manner ensures that the underlying healthy operating system continues to be updated with the latest software and/or software protection.

According to some embodiments, the critical updates are redirected to the protection partition. The critical update process restarts the local disk to clear the previous changes. This process can prevent further logins, downloads, and installs updates (to the protection partition). At substantially the same time, these changes can be committed to the local disk.

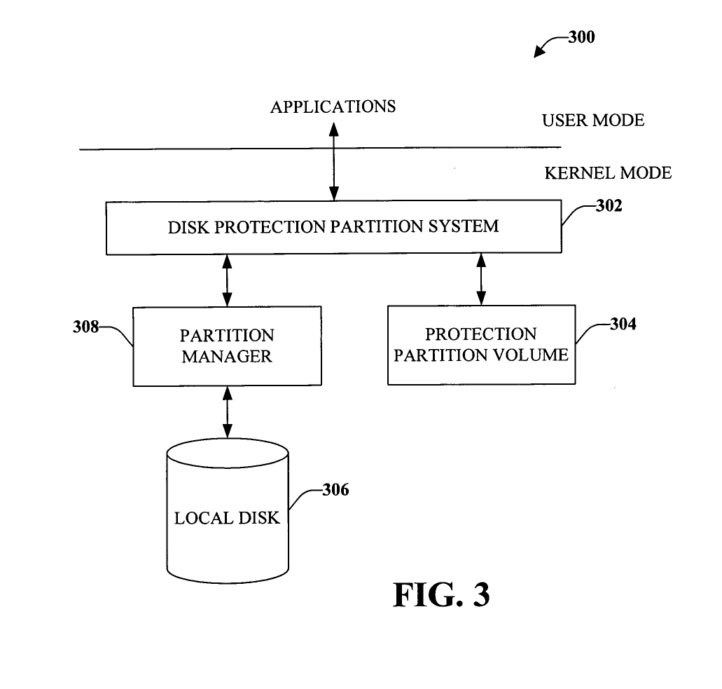

FIG. 3 illustrates a system level diagram 300 of components in a computer system that facilitate disk protection. The system 300 can be divided between a user level or mode and a kernel mode. The elements in the user level are executed in the user mode while those in the kernel mode are executed through a privileged operation. The applications applied in the user mode can be, for example, modifications, additions, and/or deletions to operating system configuration settings, installation of programs (that can also include malware and/or spyware), simple changes to the desktop environment, etc. The applications are transferred to the kernel mode for facilitation of the appropriate action.

The kernel mode consists of a disk protection partition system 302 that interfaces with a protection partition volume 304 and a local disk 306 through a partition manager 308. When a modification etc. to an application is received from the user level, the disk protection partition system 302 makes a determination whether the change should be applied directly to the local disk 306 or whether it should be maintained in a separate protection partition volume 304. If the change is to be saved in a separate protection partition volume 304, the disk protection partition system 302 redirects the application from the user mode to the partition volume 304. The change is maintained in the partition volume 304 until the user saves the change to the local disk 306 or until the change is deleted or removed, through a user request or at a next reboot.

If the application can be directly applied to the local disk 306 (e.g., critical update), the disk protection partition system 302 directs the change to the local disk 306 through the partition manager 308. During the critical update process, the disk protection partition system 302 can log off a user and/or suspend user actions to mitigate the potential of unintended and/or undesired changes being applied to the local disk 306.

The partition manager 308 can prompt a user of a domain-joined computer for a password change during a critical update process and/or a user initiated save process. Generally, in a domain-joined computer passwords should be changed periodically to ensure the integrity of the computer. When a password is changed on a domain-joined computer when disk protection is active, the new password is stored in the protection partition volume 304. If the information (e.g., new password) in the protection partition volume 304 is not saved to the local disk 306, the password might be deleted from the protection partition volume 304 on the next reboot and the local disk 306 will contain the old password. Thus, the new password is rendered inactive and authentication with the domain might not be validated. If the time window in which the password should be change has expired, the domain-joined computer will not be able to access the domain.

The partition manager 308 and/or disk protection partition system 302 can be configured to save the changes maintained in the protection partition at different checkpoints or levels. While a user is updating, modifying, deleting, adding, etc. data associated with the protection partition 304, the user may desire to save changes up to a certain point in time. For example, the user may load an application and make modifications but would also like to know if another application is compatible with the recently loaded application before applying such applications to the local disk 306. With a checkpoint level, the user can save the first application with modification at, for example, a first level. The user can then load the second application and save it at a second checkpoint or level. After further modifications, the user may save a third checkpoint. The user can then decide (one checkpoint at a time) to delete each checkpoint or save each checkpoint in the protection partition volume 304 or to the local disk 306. For example, the user may decide to apply the information stored in the first checkpoint to the local disk 306 while maintaining the information contained in checkpoint two in the protection partition 304 and deleting the information contained in checkpoint three. It is to be understood that the able example is for illustration purposes only and that more or less checkpoints and/or actions can be utilized with the disclosed systems and/or methods.

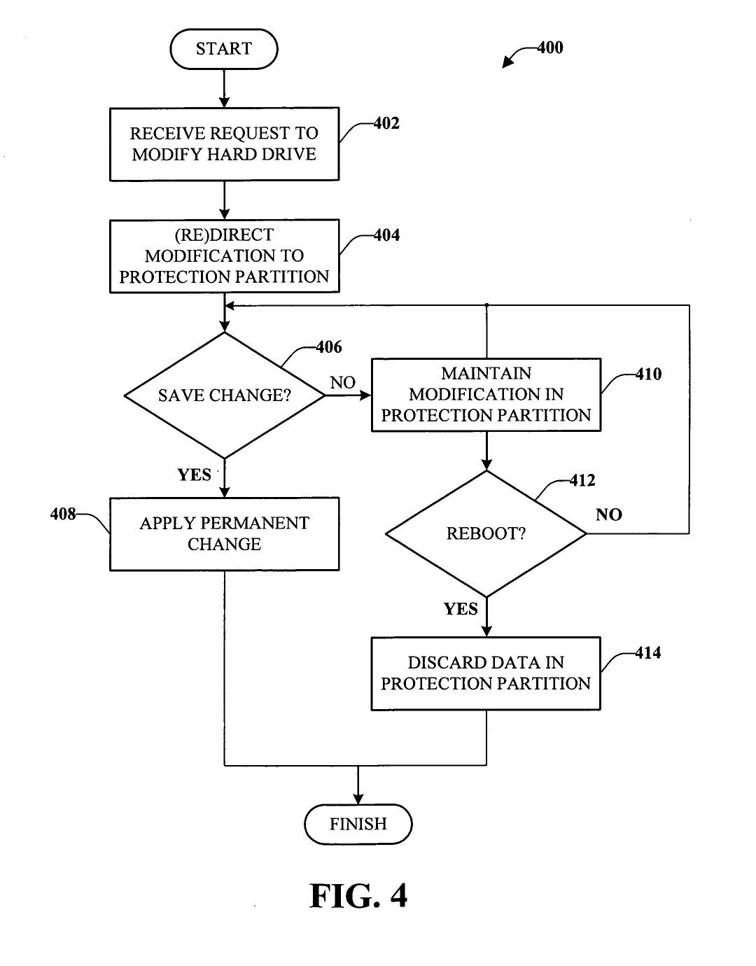

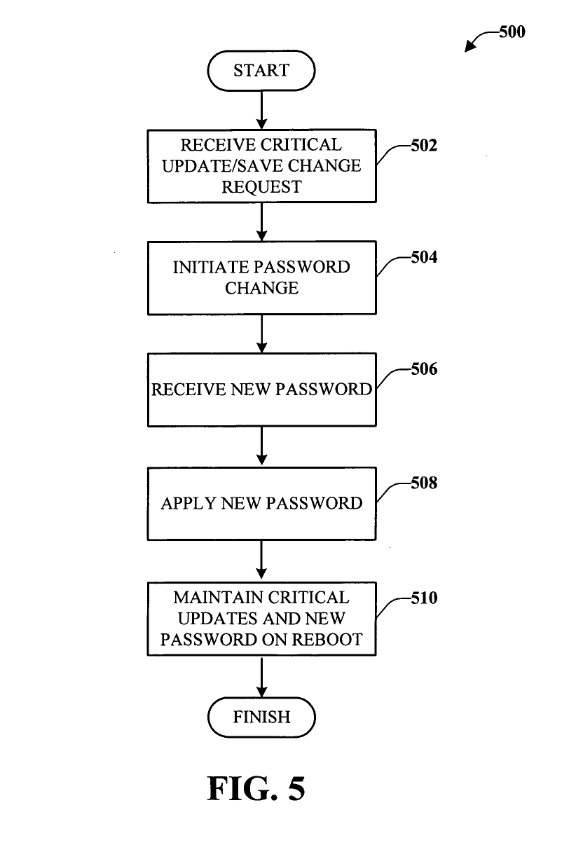

Referring to FIGS. 4-5, methodologies relating to disk protection are illustrated. While, for purposes of simplicity of explanation, the methodologies are shown and described as a series of acts, it is to be understood and appreciated that the methodologies are not limited by the order of acts, as some acts may, in accordance with these methodologies, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement the following methodologies.

FIG. 4 illustrates a flow chart of a methodology 400 for maintaining changes in a protection partition until such changes are to be permanently saved to a local disk. The method begins, at 402, when a request to modify the hard drive is received. This request can be from a user though a request to update a program, application, etc. When the request is received, it is redirected from a local hard drive (e.g., C drive) to a separate protection partition, at 404. This separate protection partition is a partition in the local drive, which was previously partitioned and reserved specifically to serve as a protection partition. It is to be understood that updates (e.g., recommended, optional) intended for the local hard drive are segregated into a protection partition with the exception of critical updates.

While the modifications are maintained in the protection partition, a determination is made whether a request to save the changes is received, at 406. This request can be from a user with the appropriate authority. If there is a request to save changes received (“YES”), the modifications are permanently applied to the local hard drive, at 408. If there is not a request to save changes (“NO”), the modifications are maintained in the protection partition, at 410. It is to be understood that the method can return to 406 and continue to monitor for a save change request.

While modifications are maintained in the protection partition, at 410, there is a determination whether a reboot or restart request is received, at 412. If there is no reboot request (“NO”), the method returns to 406 and determines if there is a save change. If there is a reboot request received, at 412, (“YES”) the modification data in the protection partition is discarded, at 414. In such a manner, upon the next restart or reboot the protection partition does not contain any data and/or modifications. It is to be understood that in an alternative embodiment, the modifications can be maintained in the protection partition at the next reboot or for a predetermined number or reboots, depending on the settings applied by a user, administrator, or other qualified user and/or entity.

FIG. 5 illustrates a flow chart of a methodology 500 for applying password changes during a critical or a save changes update to a local disk. Generally, when a computer is joined to an Active Directory domain, a machine account password can be utilized to authenticate the computer with the domain, thus allowing the computer to establish secure communications with domain controller and/or other computers in the domain. This type of joining is referred to as domain-joined. A default can be set-up so that the domain-joined computer initiates a change to the machine account password automatically at the end of a specific time period (e.g., 30 days, 60 days, 90 days, . . . ). When the password is received, a domain controller accepts the new password and allows the domain-joined computer to continue to authenticate with the domain. The domain-joined computer is denied access to the domain if the password change fails.

With the disclosed systems and/or methods, the disk protection tool disables the automatic client-initiated machine account password on the shared computer. When a password change is made, it is generally stored in the protection domain, with disk protection active. Thus, if the new password is not saved to the local disk, the new password might be discarded or removed from the protection partition upon the next reboot. Thus, the previous password would be reverted to upon restart and authentication would fail causing an inability to access the domain. Thus, a method for maintaining the password by automatically initiating a password change when disk changes are saved and, at a minimum, this can happen during a scheduled critical update process.

Referring now to methodology 500, a critical update or a “save change request” is received from a user and/or entity, at 502. The critical update and/or request to save changes can automatically apply the critical update and/or changes to the local disk permanently. The request to save changes is a request to apply the programs, applications, etc. (or a subset of such data contained in checkpoint levels) stored in a protection partition to the local disk. When such an update or request is received, the system can initiate a password change, at 504, from a user and/or entity.

When a response from the user and/or entity is received, at 506, the new password is applied to the local disk, at 508. The password, having been saved to the local disk is maintained and available upon the next reboot. The critical update(s) are also maintained and available on reboot, at 510. Upon the next reboot, the domain-joined computer can be authenticated with the domain.

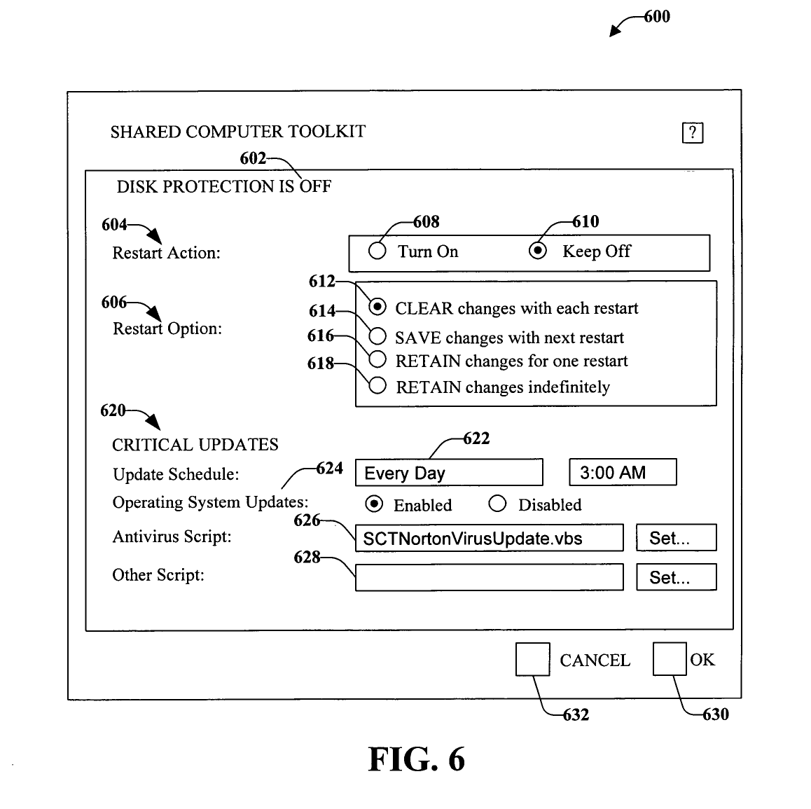

FIG. 6 illustrates an exemplary user interface 600 that can be utilized with the disclosed systems and/or methods. It is to be appreciated that other user interfaces can be utilized that can provide a graphical user interface (GUI), a command line interface, and the like. For example, a GUI can be rendered that provides a user with a region or means to load, import, read, etc. desired actions and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation can be utilized such as vertical and/or horizontal scroll bars for navigation and toolbar buttons to determine whether a region will be viewable can be employed. For example, the user can interact with the disk protection system by entering the information into an edit control.

The user can also interact with the regions to select and provide information through various devices such as a mouse, a roller ball, a keypad, a keyboard, a pen and/or voice activation, for example. Typically, a mechanism such as a push button or the enter key on the keyboard can be employed subsequent entering the information in order to initiate information conveyance. However, it is to be appreciated that the user interface 600 is not so limited. For example, merely highlighting a check box can initiate information conveyance. In another example, a command line interface can be employed. For example, the command line interface can prompt (e.g., through a text message on a display and an audio tone) the user for information by providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

It is to be appreciated that the user interface 600 provides an administrator or other authorized user a simple and efficient manner of protecting a local disk from unintended changes thorough utilization of a protection partition. Also provided is a means for the user to selectively apply or save desired changed to the local disk.

Referring to FIG. 6, an indication is given whether disk protection is “off” or “on,” shown at 602. The illustration indicates, “Disk Protection is Off.” This indication can change depending on the user requested setting(s) and provides an immediate determination of system status. The user interface 600 facilitates user changes by allowing the user to select restart actions 604 and/or restart options 606. Restart actions 604 can include turning on 608 or keeping off 610 disk protection. The user simply clicks on the circular button next to either option 608 and 610, and disk protection is either on 608 or off 610. As illustrated, the circular button includes an indication, shown at 610, such as a filled circle, for example, indicating which action is currently selected.

Restart options 606 include clearing changes with each restart 612. With this option selected, each time the computer system is rebooted or restarted, the information maintained in a protection partition is cleared or deleted. The information previously installed, downloaded, modified, etc. in the protection partition is not recoverable. This option is particularly useful for a machine that a plurality of potentially untrustworthy users have access (e.g., shared computer in a library, school, . . . ).

Another restart option 606 is to save changes with the next restart 614. With this option selected, the additions, modifications, deletions, etc. stored in the protection partition during the last session are saved to the local disk upon the next restart. In such a way, the previous changes are permanently applied to the local disk and are subsequently removed from the protection partition.

Retain changes for one restart 616 is another restart option 606 and with this option selected, the installations, modifications, additions, deletions, etc. of programs, applications, etc. maintained in the protection partition in a previous session are retained in the protection partition and available during a next session. The changes are saved in the protection partition and are not saved to a local disk until an authorized user requests such action. By retaining changes with next restart, a user can continue to modify, test, or use the application(s), program(s) after a system reboot. The retain changes for one restart 616 mode can remain in effect for only one restart. After the first restart, the tool can return to a default or clear changes with each restart 612 mode. The retain changes for one restart mode is useful for situation where programs will be installed or system changes applied that are not intended to remain permanently.

Another restart option 606 can be to retain change in the protection partition indefinitely 618. This option allows a user to continuously use, modify, monitor, etc. various applications, programs without permanently applying them to the local disk. The changes will continue to accumulate until a save changes with next restart or clear changes with each restart mode is selected. This option can be utilized with checkpoint levels that allow a user to save levels of changes retained in the protection partition. With this option selected, the protection partition should have an appropriate amount of unallocated disk space to match the size of the data that will be stored indefinitely.

The user interface 600 can include a critical update portion 620 that allows a user to select whether to automatically apply critical updates from an operating system provider and/or a trustworthy source. The user can specify an update schedule 622, which can include a day and/or time that the updates should be downloaded, if such updates are available. For example, the user can specify an update schedule that is performed daily at 3:00 a.m. It is to be understood that other schedules and/or times can be specified, such as weekly, monthly, etc. and can be performed when the system in not in use.

Operating system updates 624 can be enabled or disabled. Enabled allows the disk protection system to automatically apply the updates to the local disk while disabling saves to occur from the protection partition. Disabling saves can be accomplished by logging off a user and/or suspending user actions. Disabling the operating system updates does not apply the critical updates to the local disk automatically. With the operating system updates disabled, critical updates can still be applied manually, however, they should first be directed and retained in the protection partition and then saved to the local disk.

The user interface 600 can also provide a means for the user to automatically receive updates for an antivirus product by entering a signature update script 626. The antivirus product can also be automatically detected. By entering and setting this antivirus signature, the updates will be performed automatically as part of the critical update process if the system detects an antivirus product that it knows how to update. The user can also enter other scripts 628 for which the user desires updates to be performed automatically.

The user can exit the user interface 600 by either accepting the modifications to the disk protection system or canceling the changes. By selecting “OK” 630, the modifications made are saved and applied to the computer system. If “Cancel” 632 is selected, the modifications made on the screen are removed and the disk protection system is not updated with such changes.

The user interface 600 can also provide the user a selection to save changes made to the protection partition in levels or checkpoints. The user can selectively apply checkpoints to retain changes made while continuing to modify, monitor, etc. the information in the protection partition without applying such changes to the local disk. The user interface 600 can also provide a selection for the user to selectively delete checkpoints or levels, without affecting other checkpoints or levels.

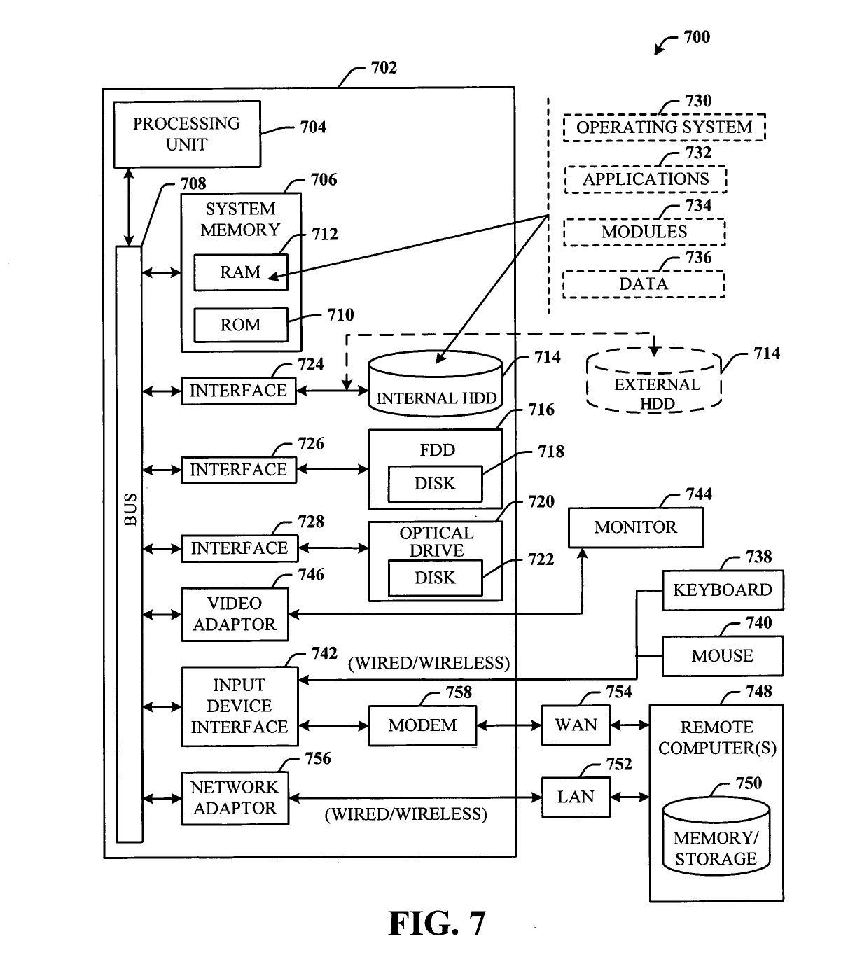

Referring now to FIG. 7, there is illustrated a block diagram of a computer operable to execute the disclosed architecture. In order to provide additional context for various aspects disclosed herein, FIG. 7 and the following discussion are intended to provide a brief, general description of a suitable computing environment 700 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the various embodiments can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 through an interface, such as a video adapter 746. In addition to the monitor 744, a computer typically includes other peripheral output devices (not shown), such as speakers, printers, etc.

The computer 702 may operate in a networked environment using logical connections through wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 through the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

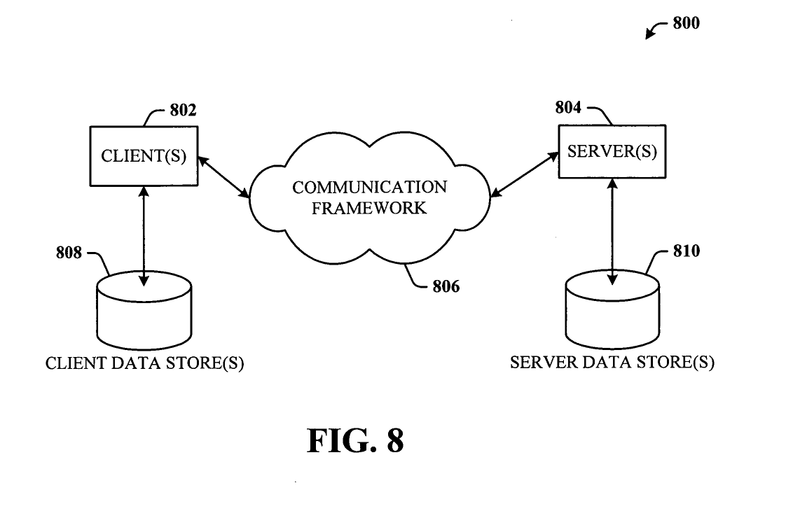

Referring now to FIG. 8, there is illustrated a schematic block diagram of an exemplary computing environment 800 in accordance with the various embodiments. The system 800 includes one or more client(s) 802. The client(s) 802 can be hardware and/or software (e.g., threads, processes, computing devices). The client(s) 802 can house cookie(s) and/or associated contextual information by employing the various embodiments, for example.

The system 800 also includes one or more server(s) 804. The server(s) 804 can also be hardware and/or software (e.g., threads, processes, computing devices). The servers 804 can house threads to perform transformations by employing the various embodiments, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated by a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system for disk protection, comprising:
a protection component that receives at least a first input and determines if the at least a first input is a permanent change or a temporary change; and
an overlay component that maintains the temporary change in a partition separate from a writable media.

2. The system of claim 1, the protection component writes the permanent change directly to the writable media.

3. The system of claim 2, a user action is suspended while the permanent change is written to the writable media.

4. The system of claim 1, the permanent change is one of a critical update and an authorized save request.

5. The system of claim 1, the writable media is reverted to a healthy state by setting the overlay component to refresh the separate partition upon a next reboot.

6. The system of claim 1, the temporary change is assigned at least one checkpoint level through a user request.

7. The system of claim 1, a password change request is received at substantially the same time as the permanent change.

8. The system of claim 7, the password change request is associated with a domain-joined machine.

9. The system of claim 1, a user selectively interacts with the system through a user interface.

10. A method for protecting a writable disk, comprising:
receiving at least a first request to modify a hard drive;
directing the at least a first request to a protection partition; and
saving the at least a first request to a writable disk if a save change request is received.

11. The method of claim 10, further comprising:
ascertaining that the at least the first request is a critical update;
suspending a user save change request option; and
applying the critical update automatically to the writable disk.

12. The method of claim 11, further comprising:
prompting a user for a password change; and
storing the password change on the writable disk at substantially the same time as the critical update is automatically applied.

13. The method of claim 1 1, the critical update is one of an operating system update and an antivirus protection update.

14. The method of claim 10, further comprising;
discarding the at least a first request in the protection partition upon a next reboot.

15. The method of claim 10, further comprising:
maintaining an indefinite number of changes in the protection partition.

16. The method of claim 10, further comprising:
saving the at least a first request to the writable media; and
removing the at least a first request from the protection partition.

17. The method of claim 10, further comprising:
receiving at least a first save protection partition changes checkpoint request;
assigning a checkpoint level; and
maintaining the checkpoint level in the protection partition.

18. A system for protecting a disk, comprising:
means for receiving a modification intended for a local disk;
means for distinguishing the modification; and
means for selectively applying the modification to a protection partition or the local disk.

19. The system of claim 18, further comprising:
means for applying critical updates automatically to the local disk; and
means for disabling a save change request during the automatic critical update.

20. The system of claim 18, further comprising:
means for prompting a user for a password change when the modification is applied to the local disk
